(19) United States
(12) Patent Application Publication
(10) Pub. No.: US 2008/0108920 A1
(43) Pub. Date: May 8, 2008

(54) Massage Device

(76) Inventor: Egidio Marcantoni, Pesaro (IT)

Correspondence Address: STITES & HARBISON PLLC, 1199 NORTH FAIRFAX STREET, SUITE 900, ALEXANDRIA, VA, 22314, US

(21) Appl. No.: 11/814,042

(22) PCT Filed: Dec. 23, 2005
(86) PCT No.: PCT/EP05/14006

§ 371 Date: Jul. 16, 2007

(30) Foreign Application Priority Data
Jan. 26, 2005 (EP) 05 001 575.9

(51) Int. Cl. A61H 7/00

(52) U.S. Cl. 601/99

(57) ABSTRACT

The invention relates to a massage device which is constructed as an independent massage block and has coupling means in order to couple the massage block detachably to a chair, the massage block having an outer covering which is of waterproof construction.

The invention relates to a massage device which together with a chair forms a massage system whereby in particular the back of a user can be massaged.

A massage system is known from EP-A-0 836 464 which has two massage elements which are driven by way of two shafts and can carry out both a tapping massage and a kneading massage.

US 2001/0052153 A1 discloses a back cushion or bed lounger with built-in massage motors. In use, a person places the massager against the back of a chair or couch and then sits down and leans back against the massaging device.

JP 2004313336 or JP 11178671 disclose massage pads which can be detachably attached to the seat or the backrest of a chair.

The object of the invention is to widen the possible uses of the massage device.

This object is achieved according to the invention by the features of claim 1.

The massage system according to the invention comprises a chair having a back part for supporting the back of a user, in particular a reclining chair, and a massage device. The massage device is constructed as an independent massage block and the chair and the massage block having coupling means which enable a detachable fixation of the massage block at the rear of the chair's back part.

The facility of releasable coupling of the massage block to a reclining chair offers the user the possibility of enjoying a massage on his reclining chair. Therefore for a massage it is not necessary to be in a special room or area where a permanently installed massage chair is set up. In addition, the chair can also be used without the massage block fixed on it.

Further embodiments of the invention are the subject matter of the subordinate claims.

According to a preferred embodiment of the invention, the massage block has an outer covering which is of waterproof construction.

The waterproof covering of the massage block also makes it possible to use the massage device in the open, for example in the immediate vicinity of a swimming pool.

In order further to increase the possible uses, the massage block is provided with a rechargeable battery which can be charged for example by way of solar cells. In another embodiment of the invention the massage block has in addition to the rechargeable battery a socket which is constructed for the preferably inductive charging of the battery.

Further advantages and embodiments of the invention are explained in greater detail with reference to the following description of some embodiments and the drawings, in which:

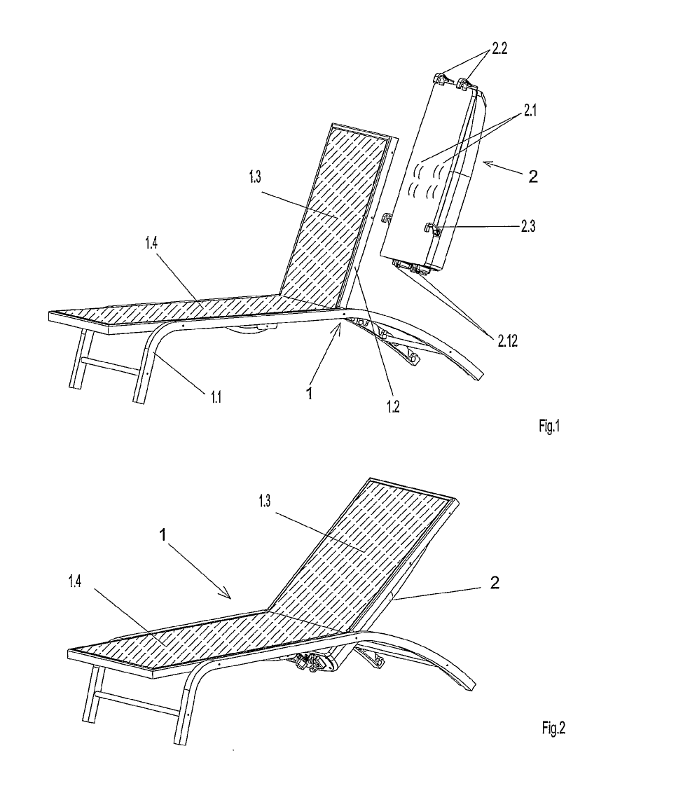

FIG. 1 shows a three-dimensional representation of the chair and of the massage block before coupling,

FIG. 2 shows a three-dimensional representation of the massage block coupled to the chair,

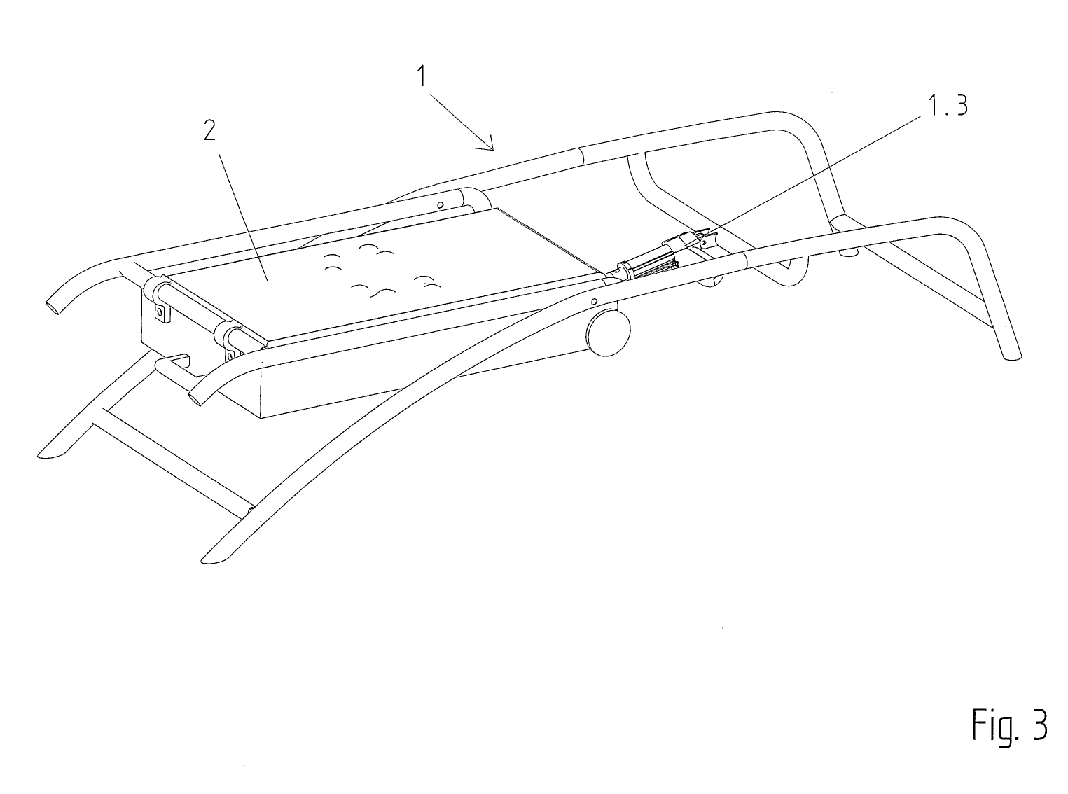

FIG. 3 shows a three-dimensional representation of the massage block coupled to the chair with the chair folded down,

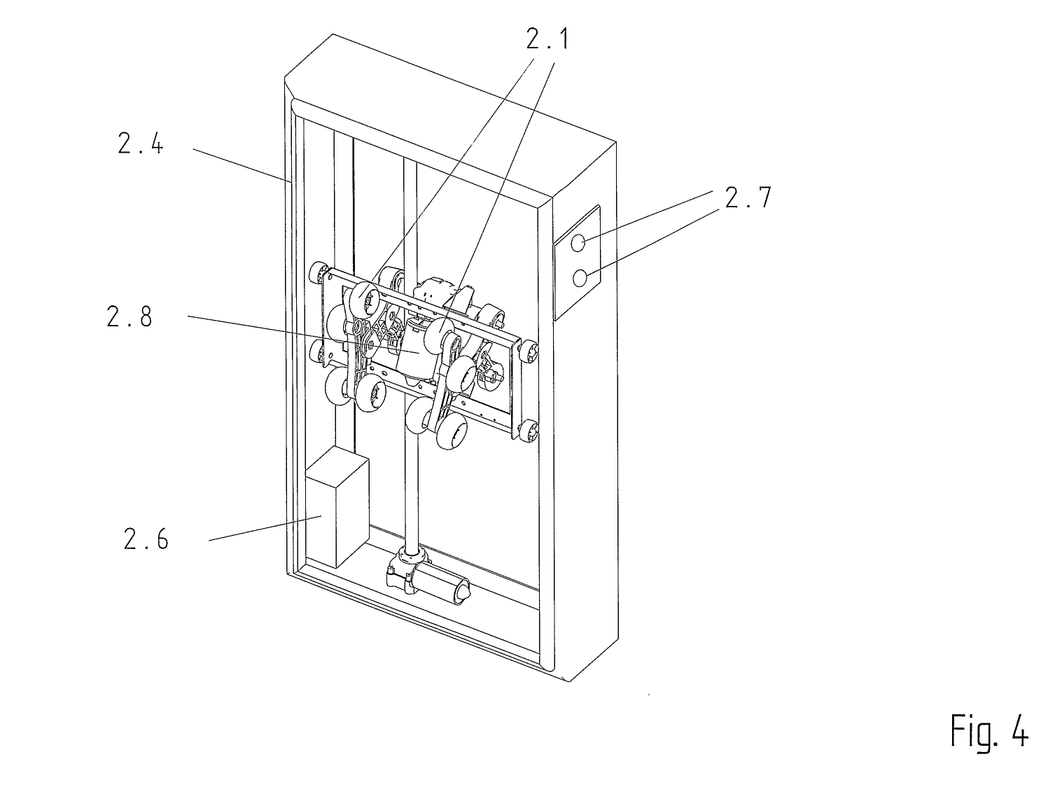

FIG. 4 shows a three-dimensional representation of the massage block without the outer covering,

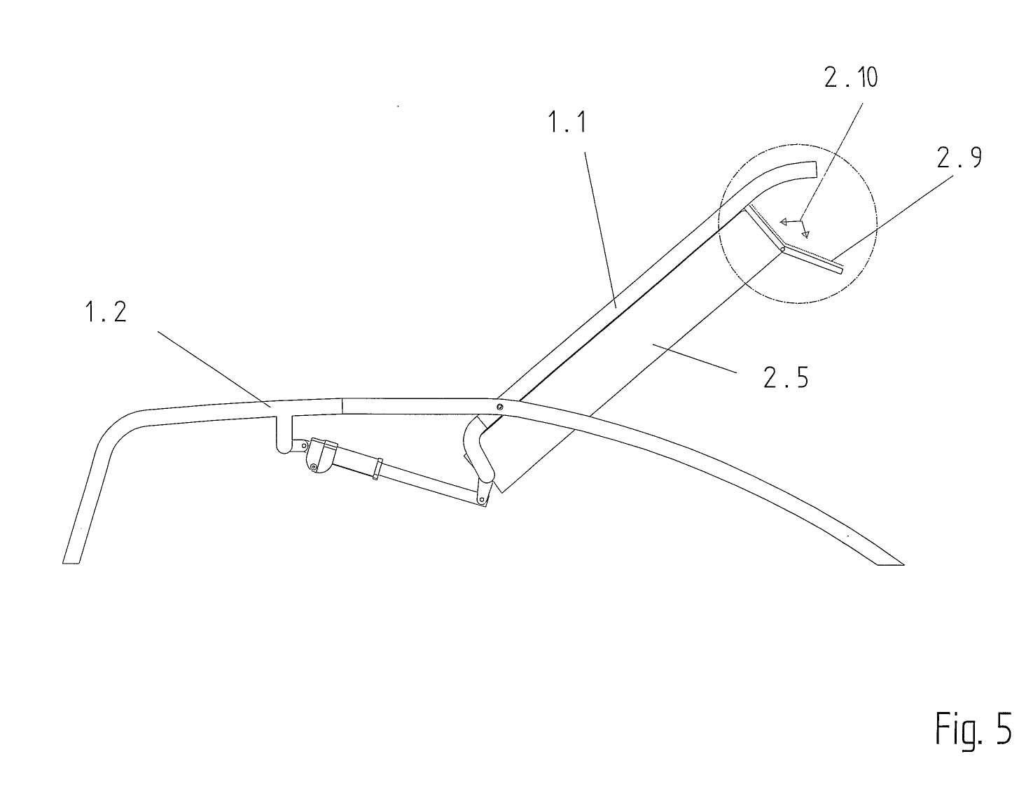

FIG. 5 shows a three-dimensional representation of the massage system with the solar cells folded out,

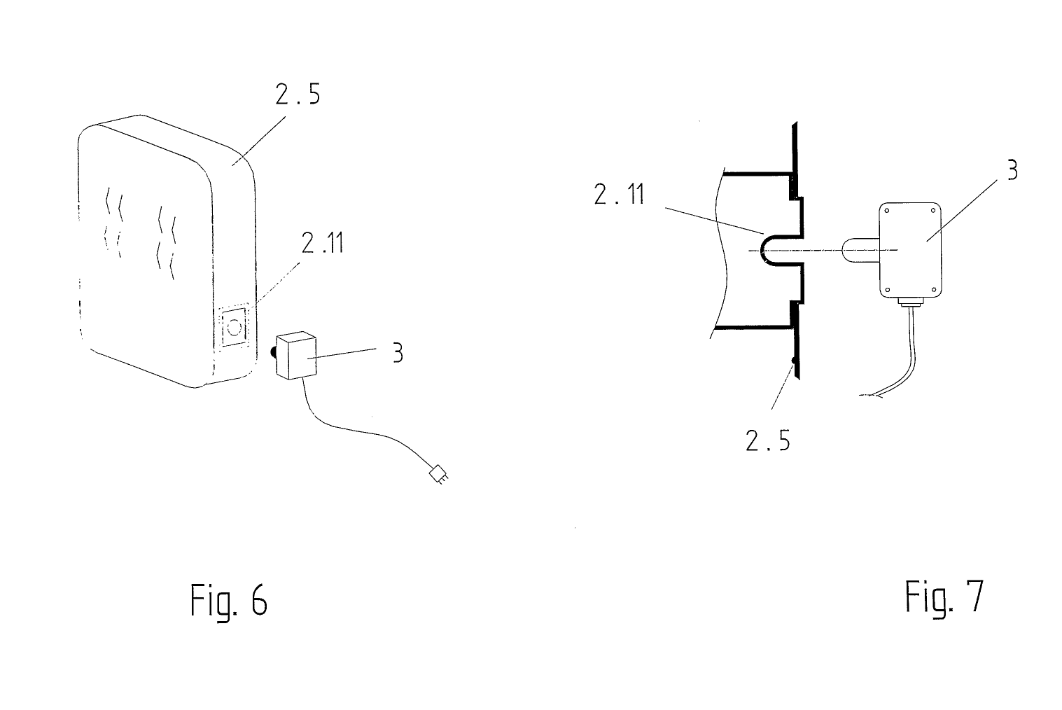

FIG. 6 shows a three-dimensional representation of the massage block showing the charging socket, and

FIG. 7 shows an enlarged representation of the massage block in the region of the charging socket.

FIG. 1 shows a massage system which principally comprises a chair 1, in particular a reclining chair and a massage block 2. In the illustrated embodiment the frame comprises a basic frame 1.1 which is supported on the floor and a back-rest frame 1.2 which is fixed thereon in an articulated manner. An actuating motor 1.3 can be provided for adjustment of the back-rest frame 1.2 relative to the basic frame 1.1, as in the illustrated embodiment.

A back part 1.3 for supporting the back of a user and seat part 1.4 are formed by a usual covering, fabric or upholstery and are fixed to the back-rest frame and the basic frame, respectively.

The massage device is constructed as an independent massage block 2 having one or more massage elements 2.1 which can be activated by way of actuating motors which are not shown in greater detail in order for example to carry out a tapping and/or kneading massage. In this case the massage elements can also be moved in the longitudinal direction, i.e. in the direction of the spinal column of the person to be massaged.

The massage block optionally has rollers 2.12 in order to make it easy to move the massage block.

Furthermore, coupling means in the form of upper hooks 2.2 and lower hooks 2.3 are provided which during coupling of the massage block to the rear of the back part 1.3 are attached to the back-rest frame 1.2 (see FIG. 2). Instead of the illustrated hooks, within the scope of the invention other couplings are of course also conceivable which for example allow the massage block to be pushed at the rear of the back part 1.3. However, it is not necessary to remove the back part before coupling the massage block to the chair.

The chair 1 can be used both with and without the fixed massage block.

If the chair is constructed so that it can be folded down, it may also be provided that the chair together with the massage block 2 can be folded down manually or by means of a motor 1.3 (FIG. 3). Only the outer frame of the chair 1 is shown in FIG. 3. The seat part and the back part the region of the seat, reclining or back-rest has been omitted in FIG. 3 for reasons of better clarity.

The massage block shown in greater detail in FIG. 4 has an outer frame 4 which is enclosed by an outer covering 2.5 (see FIGS. 5 to 7) which is of waterproof construction. A rechargeable battery 2.6 as well as a switch 2.7 which is concealed by the outer covering are provided inside the outer covering. By actuation of the switch 2.7 the massage elements 2.1 are actuated by way of at least one motor 2.8, the motor 2.8 being supplied with voltage byway of the battery 2.6.

Instead of concealing the switch 2.7 by the outer covering 2.5 and thereby reliably preventing the penetration of moisture, a switch of appropriately waterproof construction can also of course be provided on the outside of the massage block.

Although the massage block can also in principle be connected directly by a mains cable to the mains power supply, the use of a rechargeable battery increases the mobility and the possible uses of the massage block. The recharging of the battery can be carried out in various ways. It is conceivable, for instance, that for charging the battery is removed from the massage block through a suitable opening in the region of the outer covering.

However, charging can be carried out much more simply if the massage block is provided with solar cells 2.9 which are mounted on the upper end of the massage block, for example in accordance with FIG. 5. In order to avoid damage to the solar cells during transport of the massage block, the solar cells can be constructed so that they can be folded together (see double arrow 2.10).

An alternative possibility for charging the battery 2.6 is shown in FIGS. 6 and 7. According to this embodiment the massage block has a charging socket 2.11 which is connected to the battery 2.6 and which is preferably designed for inductive charging of the battery. Such a socket can be integrated particularly simply into the outer covering 2.5, whereby the penetration of moisture is reliably prevented. Then for charging an appropriately constructed plug 3 which is connected to the mains power supply is simply inserted into the charging socket 2.11.

The construction of the massage system described above ensures a very variable use, since the massage block can be detachably coupled to a chair. The waterproof covering makes it possible in particular to use the massage device in the open or in premises where contact with water or moisture cannot be ruled out. Moreover, the rechargeable battery for actuation of the massage elements provides for operation independently of the mains power supply.

1. Massage system with a chair (1) having a back part for supporting the back of a user, in particular a reclining chair, and a massage device, the massage device is constructed as an independent massage block and the chair and the massage block (2) having coupling means in order to fix the massage block detachably on the chair (1),
wherein the massage block (2) has one or more massage elements (2.1) which can be activated by way of actuating motors to carry out a tapping and/or kneading massage and wherein, the coupling means enable a fixation of the massage block (2) to the rear of the back part, and
wherein the massage block has an outer covering (2.5) which is of waterproof construction.

2. Massage system as claimed in claim 1, characterized in that the massage elements can also be moved in the longitudinal direction, i e., in the direction of the spinal column of the person being massaged.

3. Massage system as claimed in claim 1, characterized in that the massage block (2) has a rechargeable battery (2.6).

4. (canceled)

5. Massage system as claimed in claim 1, characterized in that the massage block (2) has one or more massage elements (2.1) which can be actuated by way of at least one switch (2.7), the switch being covered by the outer covering.

6. Massage system as claimed in claim 1, characterized in that the massage block (2) has solar cells (2.9) and a rechargeable battery (2.6), the battery being charged by way of the solar cells.

7. Massage system as claimed in claim 1, characterized in that the massage block (2) has solar cells and a rechargeable battery (2.6), the battery being charged by way of the solar cells and the solar cells being fixed foldably on the upper end of the massage block, wherein the solar cells can be folded out for charging of the battery and can be folded together for protection of the solar cells during transport.

8. Massage system as claimed in claim 1, characterized in that the massage block (2) has a rechargeable battery (2.6) as well as a charging socket, the charging socket (2.11) being designed for inductive charging of the battery.

9. Massage system as claimed in claim 1, characterized in that the chair can also be used without the massage block fixed on it.

10. Massage system as claimed in claim 1, characterized in that fixing elements of the massage block are hooks (2.3, 2.4).
